(19) United States
(12) Patent Application Publication
(10) Pub. No.: US 2008/0191625 A1
(43) Pub. Date: Aug. 14, 2008

(54) Discharge Lamp and Backlight Unit for Backlighting a Display Device Comprising Such a Discharge Lamp

(75) Inventors: Wim Hellebrekers, Eindhoven (NL); Piet Antonis, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/909,644

(22) PCT Filed: Mar. 8, 2006
(86) PCT No.: PCT/IB2006/050719

§ 371 Date: Sep. 25, 2007

(30) Foreign Application Priority Data
Mar. 30, 2005 (EP) 05102516.1

(51) Int. Cl. H01J 65/04; F21V 21/00

(52) U.S. Cl. 313/634; 313/631; 362/382

(57) ABSTRACT

The invention relates to a discharge lamp (1), comprising: a light-transmissive discharge vessel (2) filled with an ionizable substance, and multiple electrodes (3, 4) connected to said vessel, between which electrodes a discharge extends during lamp operation, wherein at least one electrode is adapted for capacitive coupling of RF electrical energy to said ionizable substance. The invention also relates to a backlight module for backlighting a display device comprising at least one discharge lamp according to the invention. The invention further relates to a display device provided with at least one backlight module according to the invention.

The invention relates to a discharge lamp, comprising: a light-transmissive discharge vessel filled with an ionizable substance, and multiple electrodes connected to said vessel, between which electrodes a discharge extends during lamp operation, wherein at least one electrode is adapted for capacitive coupling of RF electrical energy to said ionizable substance. The invention also relates to a backlight module for backlighting a display device, in particular an LCD unit, comprising at least one discharge lamp according to the invention. The invention further relates to a display device, in particular an LCD unit, provided with at least one backlight module according to the invention.

Hot cathode fluorescent lamps (HCFL) are well-known to backlight display devices, such as liquid crystal displays (LCD) and for other applications. A typical frequency range is between 20 kHz and 100 kHz. In this way a high frequency voltage is applied in a discharge space within a discharge vessel or tube of the HCFL forming a discharge resulting in generation of electromagnetic radiation as a result of which a display device can be illuminated. However, when relatively fast moving image material is displayed on such a display device, such as an active matrix LCD, the picture sometimes becomes blurred because of the so-called “sample and hold” effect and the slow response of the LC pixels. A scanning backlight creates a stroke of light that scrolls with the same speed of the row-addressing speed from top to bottom of the screen and reduces motion blur significantly. The scanning backlight can be generated by alternating switching the HCFLs. This means that each lamp will be in operation for a predetermined time, after which the lamp is temporarily switched off. A major drawback of using HCFLs in scanning backlight systems for illuminating a display device is that the hot cathode of the HCFL must permanently be kept at increased temperature, even in case the HFCL is temporarily turned off, to secure instantaneous correct functioning of said lamp after switching this lamp on again. This process of continuously powering the HCFL is disadvantageous from a point of view of energy. To overcome this problem it is preferable to use capacitive coupled fluorescent lamps (CCFL), which do not require continuous powering during a temporary standby state of the lamp, as a result of which an LCD can be illuminated relatively economically. The CCFL comprises a discharge vessel at the ends of which conductive coatings functioning as electrodes are applied. However, a major drawback of the known CCFLs is that the conductive coatings cover a circumferential outer part of the discharge vessel leading to two non-lighting ends, and hence a reduced effective lumen output.

It is an object of the invention to provide a discharge lamp with an improved lumen output compared to a conventional CCFL lamp.

This object can be achieved by providing a discharge lamp according to the preamble, characterized in that said discharge vessel is provided with at least one cavity for containing at least a part of the electrode being adapted for capacitive coupling of radio frequency (RF) electrical energy into said ionizable substance. By applying the electrode, or at least a part, preferably a substantial part thereof, within the cavity, covering of the discharge vessel by the electrode can be prevented, thereby resulting in an improved lumen output. Preferably, the discharge vessel is formed by a fluorescent tube, wherein an end surface of said tube is provided with the cavity. By positioning at least one electrode internally in (a cavity) of the discharge lamp, an internal capacitive coupled fluorescent lamp (ICCFL) is provided, which functioning is relatively economical and involves an improved lumen output. In the discharge lamp according to the invention it is conceivable to apply different types of electrodes, wherein at least one electrode is adapted for capacitive coupling of RF electrical energy into the ionizable substance, and wherein another electrode may for example be formed by a conventional hot cathode, thereby resulting in a hybrid type of lamp. However, in the latter embodiment the hot cathode needs to be kept permanently at increased temperature during backlight scanning as elucidated above, which is unfavourable from an economic point of view. It is therefore preferred that each electrode is adapted for capacitive coupling of RF electrical energy to said ionizable substance, which leads to a discharge lamp which functions relatively advantageously from a point of view of energy, and with which, moreover, a significantly improved lumen output can be realized with respect to conventional CCFL lamps. In a particularly preferred embodiment the discharge vessel is provided with multiple cavities for separately containing at least a part of each electrode. Preferably, these cavities are positioned at opposite ends of the discharge vessel to maximize the length of the discharge arc generated within said vessel between the electrodes.

In a preferred embodiment the at least one electrode contained at least partially within a corresponding cavity is in contact with an inner surface of said cavity, and more preferably the inner surface of said cavity is at least substantially covered by said electrode. In this manner, a capacitor is realized by the so-formed laminate of the (conducting) ionizable and/or ionized substance, the non-conducting discharge vessel acting as a dielectric, and the conducting electrode. Said electrode can thereby be formed by a conductive coating, though it is also conceivable to apply other types of electrodes, such as metal sheets or more rigid conducting elements.

Commonly, the discharge vessel is filled by means of an exhaust tube, which is connected to an end surface of the discharge vessel. After filling the discharge vessel, the exhaust tube is sealed. Preferably, at least one cavity is provided with at least a part of said exhaust tube for initial filling of the discharge vessel with the ionizable substance to prevent undesirable protrusion of said exhaust tube with respect to the discharge vessel. Moreover, preferably an outer surface of said exhaust tube is at least partially covered by an electrode to increase the capacitance of the capacitor formed by the aforementioned three layer laminate. Increasing the capacity of the capacitor leads to a decrease of loss of energetic efficiency during operation. It is commonly known that the capacity (C) of the capacitor can be calculated by ∈₀×∈ᵣ×A/d, wherein ∈₀ and ∈ᵣ are dielectric constants, A represents the contact surface between the different layers, and d represents the thickness of the intermediate dielectric layer. It is therefore advantageous to maximize the contact surface area between the electrode and the discharge vessel within, and possibly outside the cavity, preferably by making use of at least one surface increasing element connected to both the discharge vessel and the electrode contained at least partially by said cavity. It may be clear that the dimensioning and design of such a surface increasing element may be diverse. Besides increasing the contact surface area between the electrode and the discharge vessel, it is also advantageous to reduce the thickness (d) of the discharge vessel, at least at a location of the discharge vessel supporting the electrode. To further increase the contact surface area (A) between the discharge vessel and the electrode, it may be preferable that at least one electrode, which is contained partially in a cavity, is partially connected to an outer surface of the discharge vessel at a distance from said cavity. However, care should be taken not to cover an excessive part of the outer surface of the discharge vessel to prevent a (considerable) loss of effective lumen output.

To allow generation of a discharge arc within the discharge vessel, preferably the discharge lamp further comprises a RF source electrically coupled to the at least one electrode, or multiple electrodes being adapted for coupling of RF electrical energy to said ionizable substance.

Commonly, the discharge vessel comprises at least one elongated envelope, in particular a fluorescent tube. In another preferred embodiment said discharge vessel comprises multiple elongated envelopes mutually coupled for example by means of an (open) bridge as to enclose together a single discharge space. In this manner, two, three, four or even more envelopes may be bridged together to form a single discharge lamp.

In an alternative preferred embodiment each cavity for containing an electrode is at least partially provided within an ancillary container connected to the discharge vessel. Said container is preferably not covered with a phosphorous coating. According to this embodiment the discharge vessel (practically) as a whole including any end surfaces can be used for output of light. More preferably, multiple of such containers are provided to improve the lumen output by eliminating the electrodes to be directly coupled to the discharge vessel.

Preferably, the discharge lamp further comprises a phosphorous coating for converting UV light generated within said envelope into visible light, said phosphorous coating being applied onto a substantial part of an inner surface of the discharge vessel. More preferably, an inner surface of the discharge vessel is completely covered by said phosphorous coating. Since the presence of the cavities leads to an increased inner surface area of the discharge vessel the amount of phosphorous coating to be applied can also be increased, leading to an increased conversion of UV light into visible light, and hence an improved lumen output.

The invention also relates to a discharge vessel for use in a discharge lamp according to the invention, said discharge vessel being provided with at least one cavity for containing at least a part of an electrode being adapted for coupling RF electrical energy to an ionizable substance. Preferably, said discharge vessel is provided with multiple cavities for separately housing a multiplicity of such electrodes. Said cavities are preferably located at (or near) end surfaces of the discharge channel, which is preferably of an elongated shape. Additional advantages and preferred embodiments of the discharge vessel according to the invention are elucidated above in a comprehensive manner.

The invention further relates to a backlight module for backlighting a display device, in particular an LCD unit, comprising: holding means for holding at least one discharge lamp according to the invention, and supply means for energizing said discharge lamp. Preferably, said holding means are adapted for holding multiple discharge lamps according to the invention.

Moreover, the invention relates to a display device, in particular an LCD unit provided with at least one backlight module according to the invention. Besides LCDs all kinds of displays can be used which require active illumination by one or more discharge lamps according to the invention.

The invention can further be illustrated by way of the following non-limitative embodiments, wherein:

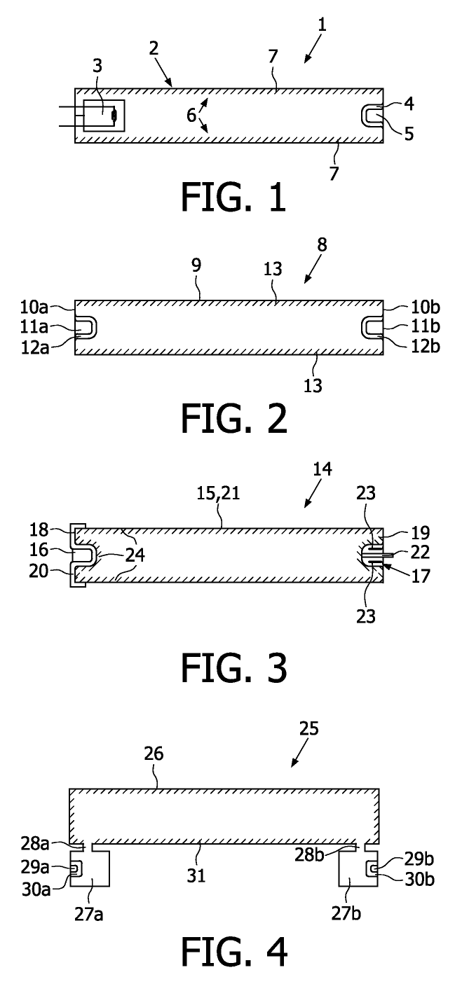

FIG. 1 shows a side view of a first embodiment of a fluorescent lamp according to the invention,

FIG. 2 shows a side view of a second embodiment of a fluorescent lamp according to the invention,

FIG. 3 shows a side view of a third embodiment of a fluorescent lamp according to the invention,

FIG. 4 shows a side view of a fourth embodiment of a fluorescent lamp according to the invention,

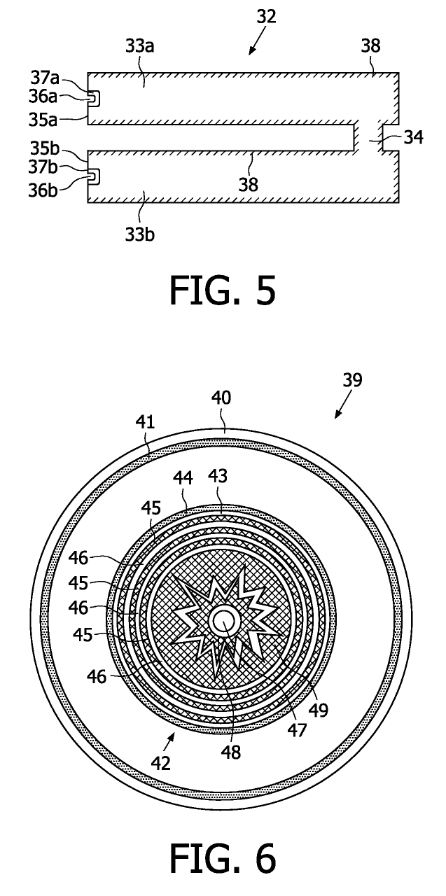

FIG. 5 shows a side view of a fifth embodiment of a fluorescent lamp according to the invention, and

FIG. 6 shows a cross section of an alternative embodiment of a discharge lamp according to the invention.

FIG. 1 shows a side view of a first embodiment of a fluorescent lamp 1 according to the invention. The lamp 1 comprises an elongated substantially cylindrical discharge vessel 2 made of glass and filled with an ionizable substance, such as a mixture of mercury with a noble gas. One end of said discharge vessel 2 is provided with a hot cathode electrode 3, while an opposite end of said vessel 2 is provided with an alternative electrode 4. Said alternative electrode 4 is provided within a hollow space 5 provided to the other end of said vessel 2. Said alternative electrode 4 is formed by a conducting layer, such as a metal, in particular copper, layer, thereby forming together with the vessel and the ionizable substance a capacitive coupling for transferring RF electrical energy to said ionizable substance. Since the alternative 4 electrode is positioned within said hollow space 5, an inner curved surface 6 of said discharge vessel 2 can be covered completely with a phosphorous coating 7 for converting UV light generated within said vessel 2 into visible light thereby leading to an improved lumen output with respect to conventional capacitive coupled fluorescent lamps.

FIG. 2 shows a side view of a second embodiment of a fluorescent lamp 8 according to the invention. The lamp 8 shown in FIG. 2 is constructively symmetrical and comprises a medium tight cylindrical discharge envelope 9 filled with an ionizable substance. Both end surfaces 10a, 10b are provided with a cavity 11a, 11b. Each cavity 11a, 11b thereby forms a housing for a conducting electrode 12a, 12b to realize a capacitive coupling for RF energy to be coupled into said envelope 9. This embodiment of the fluorescent lamp 8 is preferable over the embodiment of the lamp 1 shown in FIG. 1, since a capacitive coupling is significantly more advantageous than a hot cathode electrode from a point of view of energy, in particular in case the lamps 1, 8 are used for scanning backlighting. As can be seen in FIG. 2, a phosphorous coating 13 is applied to a complete (curved) inner surface of the envelope 9 to convert non-visible light into visible light. It is noted that the cavities 11a, 11b may also be provided with the curved surface of the envelope 9 (instead of the end surfaces 10a, 10b).

FIG. 3 shows a side view of a third embodiment of a fluorescent lamp 14 according to the invention. The lamp 14 comprises an elongated cylindrical discharge vessel 15 made of a non-conductive material and filled with an ionizable substance, said vessel 15 being provided with two cavities 16, 17 which are situated at opposite end surfaces 18, 19 of said vessel 15. A first cavity 16 is partially filled with a first electrode 20. A part of said first electrode 20 is, however, situated outside said first cavity and covers the corresponding end surface 18 substantially completely as well as a small part of a curved surface 21 of the vessel 15 in order to increase the contact surface area between the first electrode 20 and the vessel 15. In this manner, the capacity of the capacitor formed by the laminate of the electrode 20, the vessel 15 and the substance contained therein can be increased, resulting in a reduced loss of energetic efficiency during lamp operation. A second cavity 17 is provided with a (sealed) exhaust tube 22 originally adapted for initial filling of the vessel 15 with the ionizable substance. Within the remaining free space of the second cavity 17, a second electrode 23 is applied. The second electrode 23 thereby engages both an inner surface of the second cavity 17 and an outer surface of the exhaust tube 22 to maximize the contact surface area between second electrode 23 and the vessel 15. This second electrode 23 is, like the first electrode 20, also adapted to make part of a capacitor for coupling of RF energy into said vessel 15. The complete inner surface of the vessel 15 including the surface of the cavities 16, 17 is covered with a phosphorous coating 24 to maximize the conversion of UV-light into visible light.

FIG. 4 shows a side view of a fourth embodiment of a fluorescent lamp 25 according to the invention. The lamp 25 comprises a cylindrical discharge vessel 26 to which two external hollow containers 27a, 27b are connected by means of hollow bridges 28a, 28b. Each external container 27a, 27b is provided with a cavity 29a, 29b for housing an electrode 30a, 30b. An inner surface of the vessel 26 is (substantially) completely covered with a phosphorous coating 31 for converting UV light into visible light. Preferably, said external containers 27a, 27b are not provided with such a coating to prevent generation of visible light during a (temporary) turn-off of the lamp 25, for example during scanning backlighting.

FIG. 5 shows a side view of a fifth embodiment of a fluorescent lamp 32 according to the invention. Said lamp 32 comprises two elongated discharge vessels 33a, 33b which are mutually in communication by means of a hollow bridge 34. An end surface 35a, 35b of each vessel 33a, 33b is provided with a cavity 36a, 36b for housing an electrode 37a, 37b to allow capacitive coupling of RF energy into said vessels 33a, 33b. A phosphorous coating 38 is applied to a substantially complete inner surface of the vessels 33a, 33b including the bridge 34. As is shown, a single ended internal capacitively coupled fluorescent lamp 32 may be formed in this way.

FIG. 6 shows a cross section of an alternative embodiment of a discharge lamp 39 according to the invention. Said lamp 39 comprises a cylindrical discharge vessel 40 filled with an ionizable substance, an inner surface of which vessel 40 is coated by a phosphorous coating 41. Concentrically in an end surface of said vessel 40 a cavity 42 is provided, the circumference of which cavity 42 is defined by a recessed wall part 43 made of quartz glass. An outer side of this wall part 43 is also covered by a phosphorous coating 44. In the embodiment shown the cavity 42 is completely filled with conducting layers 45, which conducting layers 45 are separated by non-conducting (dielectric) layers 46. In the center of the cavity 42 a sealed exhaust tube 47 is provided. Said exhaust tube 47 is covered by a surface increasing (conductive) element 48, which surface increasing element 48 is surrounded by a non-conductive layer 49. The space between the latter non-conductive layer 49 and the subsequent non-conductive layer 46 is filled with the conductive material. In this way, a capacitor with a significantly improved capacitance can be realized, which leads to a considerable loss of energetic efficiency during operation of the discharge lamp 39.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements.

1. Discharge lamp, comprising:
a light-transmissive discharge vessel filled with an ionizable substance, and
multiple electrodes connected to said vessel, wherein a discharge extends between the electrodes during lamp operation, wherein at least one electrode is adapted for capacitive coupling of RF electrical energy to said ionizable substance, wherein said discharge vessel is provided with at least one cavity for containing at least a part of the electrode being adapted for capacitive coupling of RF electrical energy into said ionizable substance.

2. Discharge lamp according to claim 1, characterized in that each electrode is adapted for capacitive coupling of RF electrical energy to said ionizable substance.

3. Discharge lamp according to claim 1, characterized in that the discharge vessel is provided with multiple cavities for separately containing at least a part of each electrode.

4. Discharge lamp according to claim 1, characterized in that the at least one electrode contained at least partially within a corresponding cavity is in contact with an inner surface of said cavity.

5. Discharge lamp according to claim 4, characterized in that the inner surface of said cavity is at least substantially covered by said electrode.

6. Discharge lamp according to claim 1, characterized in that at least one cavity is provided with at least a part of an exhaust tube for initially filling the discharge vessel with the ionizable substance.

7. Discharge lamp according to claim 6, characterized in that an outer surface of said exhaust tube is at least partially covered by an electrode.

8. Discharge lamp according to claim 1, characterized in that at least one electrode comprises a conductive sheet, in particular a coating.

9. Discharge lamp according to claim 1, characterized in that at least one cavity is provided with at least one surface increasing element connected to both the discharge vessel and the electrode contained at least partially by said cavity for increasing the contact area between said discharge vessel and said electrode.

10. Discharge lamp according to claim 1, characterized in that at least one electrode, which is contained partially within a cavity, is partially connected to an outer surface of the discharge vessel at a distance from said cavity.

11. Discharge lamp according to claim 1, characterized in that the discharge lamp further comprises a RF source electrically coupled to the at least one electrode being adapted for coupling RF electrical energy to said ionizable substance,

12. Discharge lamp according to claim 1, characterized in that said discharge vessel comprises at least one elongated envelope.

13. Discharge lamp according to claim 12, characterized in that said discharge vessel comprises multiple elongated mutually coupled envelopes.

14. Discharge lamp according to claim 1, characterized in that each cavity for containing an electrode is at least partially provided in an ancillary container connected to the discharge vessel.

15. Discharge lamp according to claim 1, characterized in that the discharge lamp further comprises a phosphorous coating for converting UV light generated within said envelope into visible light, said phosphorous coating being applied onto a substantial part of an inner surface of the discharge vessel.

16. Discharge vessel for use in a discharge lamp according to claim 1, said discharge vessel being provided with at least one cavity for containing at least a part of an electrode being adapted for coupling of RF electrical energy to an ionizable substance.

17. Backlight module for backlighting a display device, comprising:
holding means for holding at least one discharge lamp according to claim 1, and
supply means for energizing said discharge lamp.

18. Display device provided with at least one backlight module according to claim 17.
